(19) United States
(12) Patent Application Publication
(10) Pub. No.: US 2010/0320275 A1
(43) Pub. Date: Dec. 23, 2010

(54) STRUCTURE FOR RADIO FREQUENCY IDENTIFICATION AND ITS MANUFACTURING METHOD

(75) Inventor: I-Ju Fu, Longtan Township (TW)

Correspondence Address: G. LINK CO., LTD., 2885 Sanford Ave SW #13265, Grandville, MI, 49418, US

(73) Assignee: Elka Internationl Ltd., Hsichih City (TW)

(21) Appl. No.: 12/486,739

(22) Filed: Jun. 17, 2009

(51) Int. Cl. G06K 19/06

(52) U.S. Cl. 235/492

(57) ABSTRACT

A improved structure RFID includes: a substrate with an entire side of a metal conductive material; a slot antenna disposed on the metal side of the substrate; and an identification chip disposed on the substrate and electrically connected to the slot antenna. The RFID is manufactured using a simpler and cheaper method, so manufacturing costs are significantly reduced while providing low energy consumption, pollution-free, recyclability, and the RFID has high antenna gain, strong reflectivity, and high conductivity. Shield effects provided by the whole metal side of the substrate can also reduce effects to the electrical properties of the RFID caused by the target object and the environment, so the RFID is more suitable for metal objects and conductors with moisture.

### BACKGROUND OF THE INVENTION

1. Field of the Invention

The present invention relates to an improved structure for radio frequency identification and its manufacturing method, and, more particularly, to an RFID having a slot antenna on its conductive substrate which can provide high antenna gain, strong reflectivity, and high conductivity.

2. Description of the Related Art

The RFID (radio frequency identification), also called an electronic tag, is a communication technology between an identification system and a specific target via radio signals without mechanical or optical contacts.

Currently, passive RFID tags are more popular, because they are cheaper and require no power. In practice, an identification chip in an RFID tag is driven by the electromagnetic wave from an RFID reader; when the tag receives a sufficient signal it sends data to the reader. This data includes an ID number (globally unique ID) and information pre-stored in an EEPROM on the tag.

The RFID can be applied in many different fields and combined with a database management system, computer network or firewall technologies to provide an automatic, safe, and convenient real-time monitoring system. The applicable fields include, bills, products with anti-counterfeiting labels, identification cards, passes, electronic toll collection, logistics management, flight luggage monitoring, automatic production management control, inventory management, transportation monitoring, security control, medical management, etc.

As shown in FIG. 1, in order to make prior art radio frequency tags, etching, printing, sputtering, etc, are performed to form a conductive emulsion antenna on plastic film or a paper substrate and then the identification chip is planted onto the antenna. However, this manufacturing method is complicated and expensive; the conductive emulsion antenna has a very limited area; the shield effect of the surrounding plastic film or paper substrate is poor so that the electrical properties of the RFID are easily affected by metal and moisture in the background environment, and as a consequence the RFID reader cannot correctly read the data.

Furthermore, the application of the prior art RFID has the following problems:

1. High cost: very expensive machinery is required to perform printing for the antennas or etching on the plastic film or paper substrate. In addition, emulsion is a high cost, perishable material, while high cost pollution treatment processes for etching also increase the manufacturing costs of the antenna of the radio frequency tag.

2. Low yield: the emulsion printing materials for emulsion and sputtering are in particulate form, which has poor conductivity in comparison to continuous conductive metal materials, and the finished antenna tends to break and fail easily. Etching may cause poor and discontinuous conductivity of the antenna due to under-exposure or over-exposure.

3. Low accuracy of electrical properties: due to uneven thickness of the emulsion and uneven etching, the electrical conductivity and magnetic induction of the antenna impedance may be unevenly distributed which causes frequency drift and impedance mismatching of the antenna so that accuracy is hard to control and the failure rate is increased.

4. Low endurance: the printing emulsion frequently evaporates, while corrosion of etched wires, all make the radio frequency tag hard to stock with a short operational lifetime.

5. High customization costs: in order to satisfy the desired characteristic requirements for a target object of the customer, which may include frequency drift, impedance changes, etc, screen plate for printing or etching to form the antennas is required. Then, after actual testing, a new screen plate is required for printing, etching and testing according to the offset value of the electrical properties. After all of these repeated procedures, the customization costs are very high and the goal of single material preparation and single stocks cannot be achieved.

Therefore, it is desirable to provide an improved structure for radio frequency identification and its manufacturing method to mitigate and/or obviate the aforementioned problems.

### SUMMARY OF THE INVENTION

The improved structure of an RFID of the present invention comprises: a substrate with an entire side of metal conductive material; a slot antenna disposed on the metal side of the substrate; and an identification chip disposed on the substrate and electrically connected to the slot antenna. Subsequently, the RFID is manufactured using a simpler and cheaper method, so that manufacturing costs are significantly reduced, while enjoying the benefits of low power energy consumption, no pollution, recyclability, and an RFID having high antenna gain, strong reflectivity, and high conductivity. Furthermore, the shield effect provided by the entire metal side of the substrate can also reduce the effects of the electrical property of the RFID caused by the target object and the environment, so the RFID is more suitable for metal objects and conductors with moisture.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a prior art radio frequency tag structure.

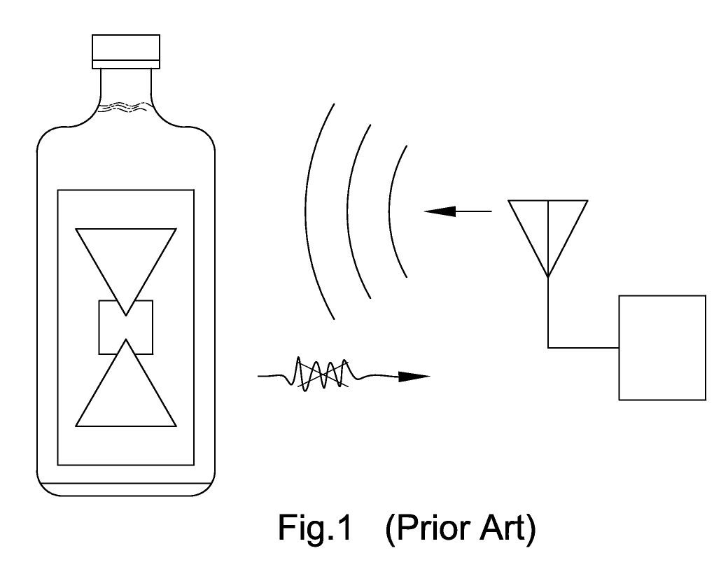

FIG. 2 is a top view drawing of a radio frequency tag according to the present invention.

FIG. 3 is a top view drawing of a two-sided asymmetrical closed radio frequency tag according to the present invention.

FIG. 4 is a top view drawing of a two-sided opened radio frequency tag according to the present invention.

FIG. 5 is a top view drawing of a single-sided opened radio frequency tag according to the present invention.

FIG. 6 is a block drawing of a manufacturing method according to the present invention.

FIG. 7 is a schematic drawing of the manufacturing method according to the present invention.

FIG. 8 is a manufacturing flowchart according to the present invention.

FIG. 9 is a schematic drawing of processing a stored semi-finished product according to the present invention.

FIG. 10 is a schematic drawing of making slot antennas into different shapes according to the present invention.

FIG. 11 is a schematic drawing of a preferred embodiment of a radio frequency tag according to the present invention.

FIG. 12 is a schematic drawing of disposing a radio frequency tag on a metal housing according to the present invention.

### DETAILED DESCRIPTION OF THE PREFERRED EMBODIMENT

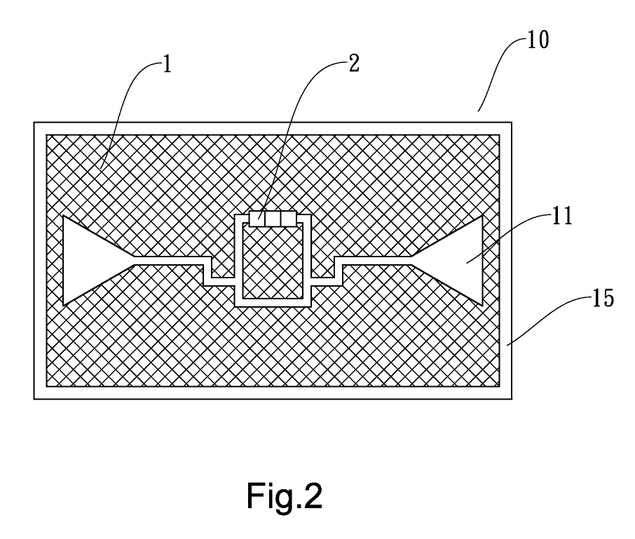

As shown in FIGS. 2˜3, an RFID tag 10 of the present invention comprises:

a substrate 1 with an entire side of metal conductive material;

a slot antenna 11 disposed on the metal side of the substrate 1; and

an identification chip 2 disposed on the substrate and electrically connected to the slot antenna.

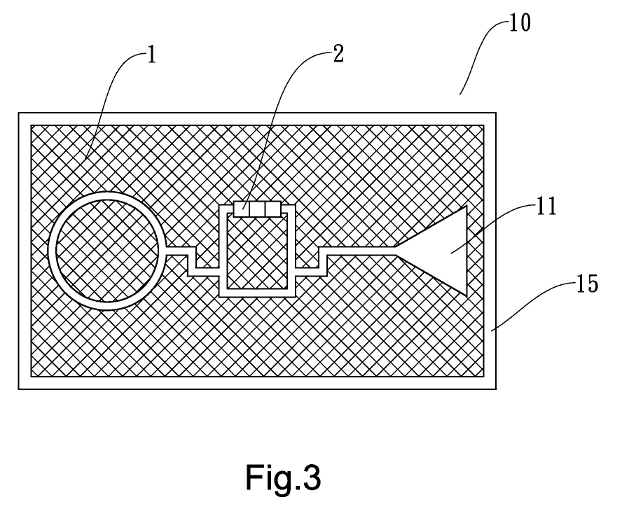

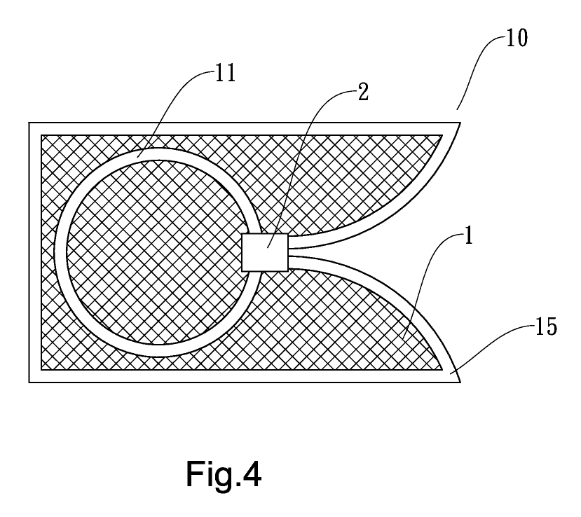

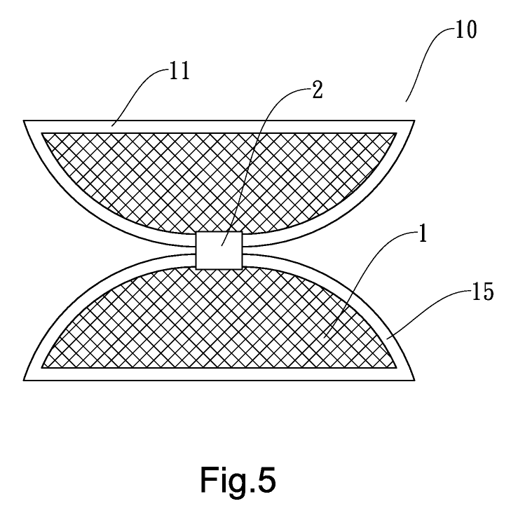

The finished tag 10 can be laminated with a lamination frame 15 and be provided with different configurations; for example, the slot antenna 11 of the substrate 1 may have two symmetrical (as shown in FIG. 2) or two asymmetrical (as shown in FIG. 3) closed slots, or a two-sided opened slot (as shown in FIG. 4), or a single closed slot and one opened slot (as shown in FIG. 5).

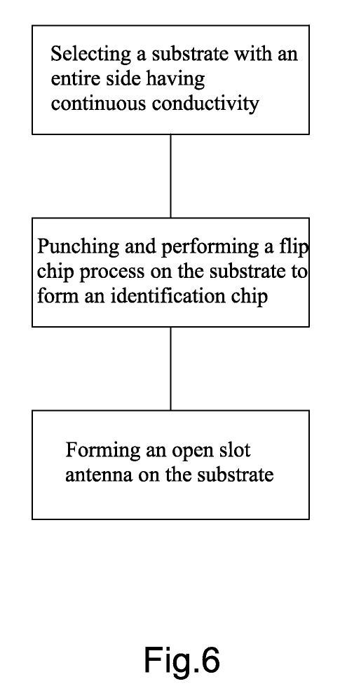

Since the RFID of the present invention is very different from the prior art structure, a more simplified and efficient manufacturing method is performed. As shown in FIGS. 6˜7, the manufacturing method comprises:

(A) selecting a substrate 1 with an entire side having continuous conductivity;

(B) punching and performing a flip chip process on the substrate 1 to form an identification chip 2; and

(C) forming an slot antenna 11 on the substrate.

Alternatively, step (B) and step (C) can be switched to form the slot antenna 11 first and then place the identification chip 2, which is a trivial variation that requires no further description.

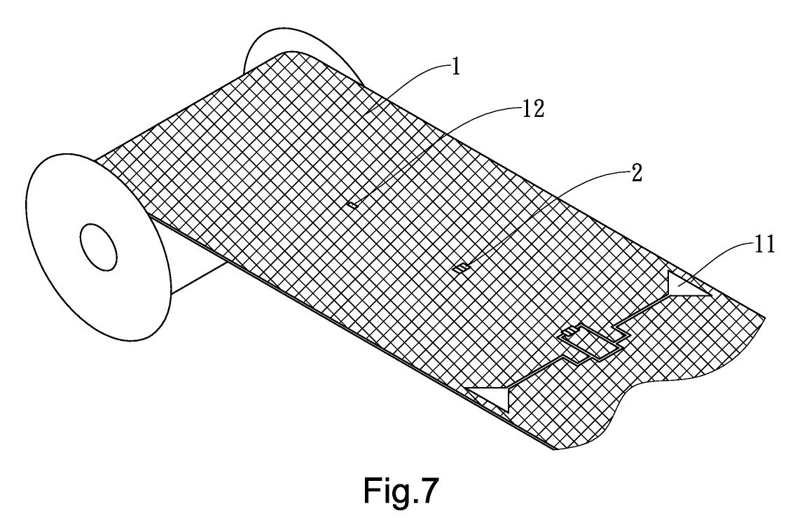

As shown in FIGS. 7˜8, the manufacturing method further comprises:

the substrate: using an aluminum foil or tin foil conductive metal as an antenna substrate 1;

spreading: spreading the substrate 1 until its thickness is below μm in size and rolling the substrate into separate rolls;

punching: punching holes 12 at the specific distance for the pins of the identification chip 2 on the substrate 1;

performing the flip chip process: attaching the identification chip 2 on the punched and rolled up substrate 1 via a conductive transfer tape (either anisotropic or non-anisotropic conductive transfer tape may be used) (not shown);

forming the antenna: cutting the substrate 1 to form the slot antenna 11; and

remaining processes: performing the resin coating and filming processes to form the RFID 10 (Inlay).

Aluminum foil, tin foil or conductive metal materials may be used as the substrate 1. The flip chip process is performed directly and a cutting mould or laser cutter may be utilized to cut the slot antenna 11 into the RFID tag 10. This manufacturing method is novel, practical, simple with respect to materials and procedures, and provides a high product yield. Additionally, the manufacturing process does not require a high cost printing machine or an etching machine; therefore, it is low cost, low power consumption, energy saving, pollution-free, and recyclable. It completely overcomes the drawbacks of expense, pollution, time wasting and stocking inconvenience of the traditional printing, etching and sputtering processes.

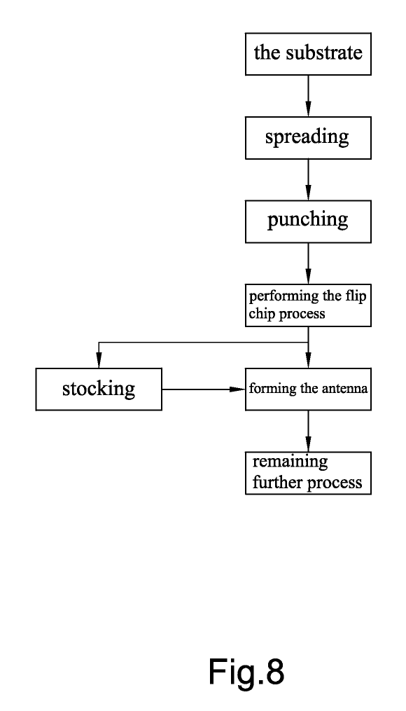

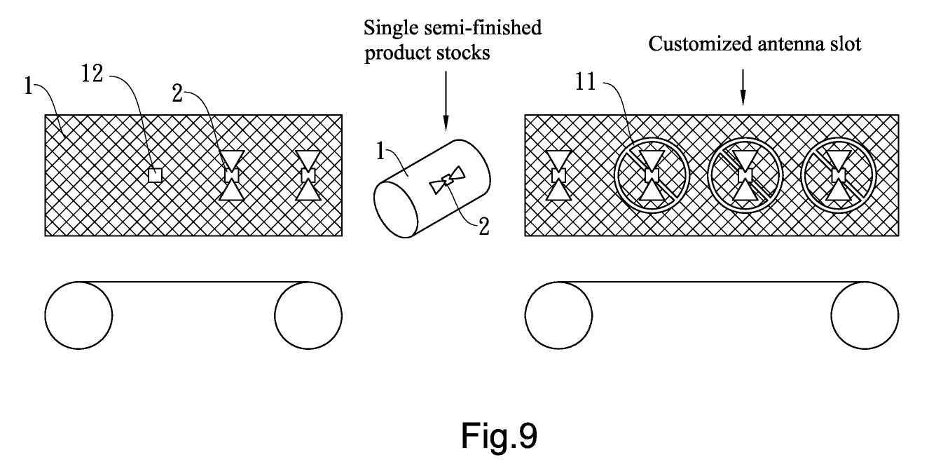

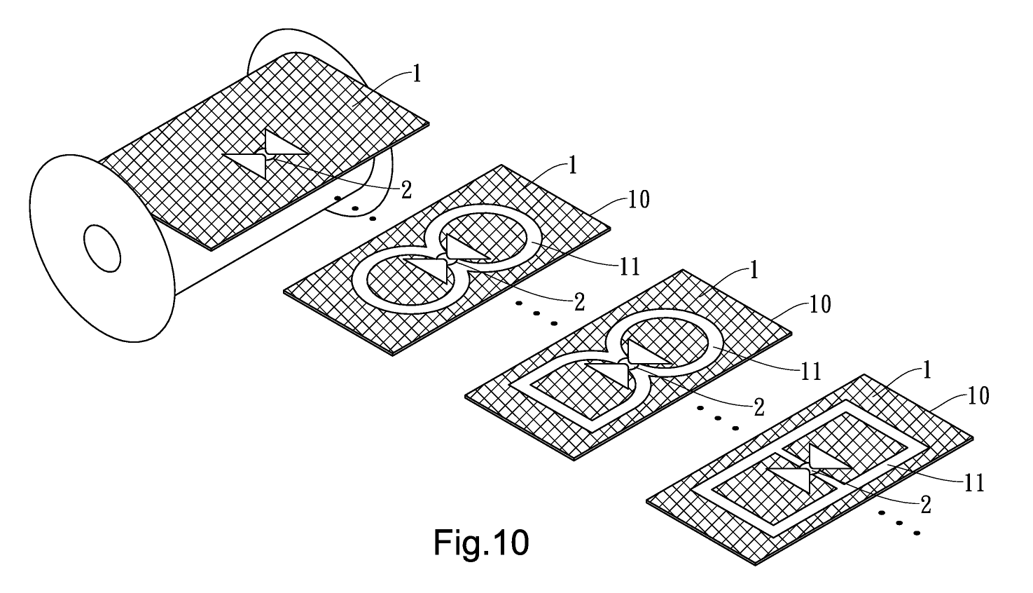

As shown in FIG. 8 and FIG. 9, an important characteristic of the present invention is not just the continuous antenna formation, but also flipping the identification chip 2 on the aluminum foil substrate 1 to avoid oxidation of the die. The rolled up substrate 1 after the flip chip process is for stocking purposes; and the substrate 1 after the flip chip process may be cut into the slot antenna according to customized designs, as shown in FIG. 10.

Since the slot antenna II is directly formed on the metal substrate 1, compared to the traditional antenna formed by the printing or etching processes, the finished RFID tag 10 has high antenna gain, strong reflectivity, and high conductivity. Consequently, the effective range of RFID system is extended further (140%).

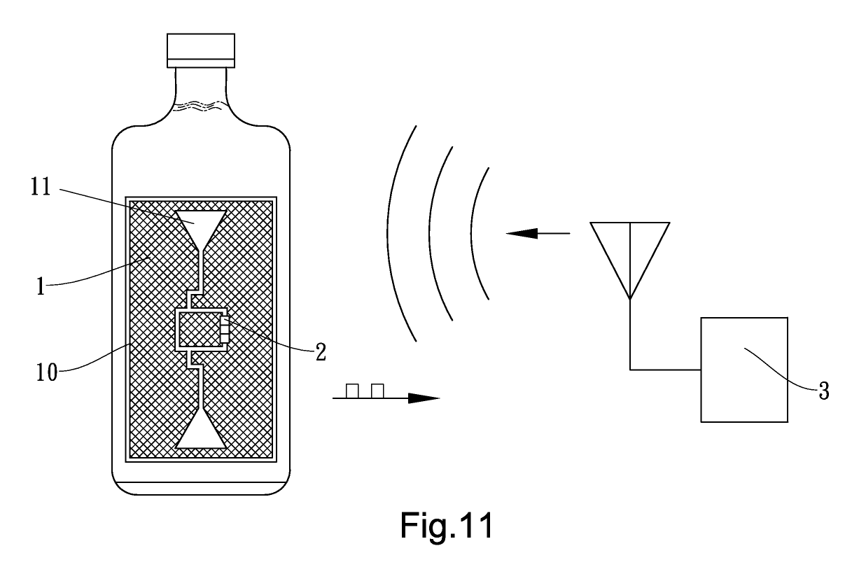

As shown in FIG. 11, the metal substrate 1 of the RFID tag 10 has a large area screening effect which can efficiently reduce the electrical property effects on the RFID tag 10 caused by the target object and the environment. Therefore, the RFID tag 10 is more suitable for metal objects or conductive target objects with moisture and is more accurately read by the RFID reader 3.

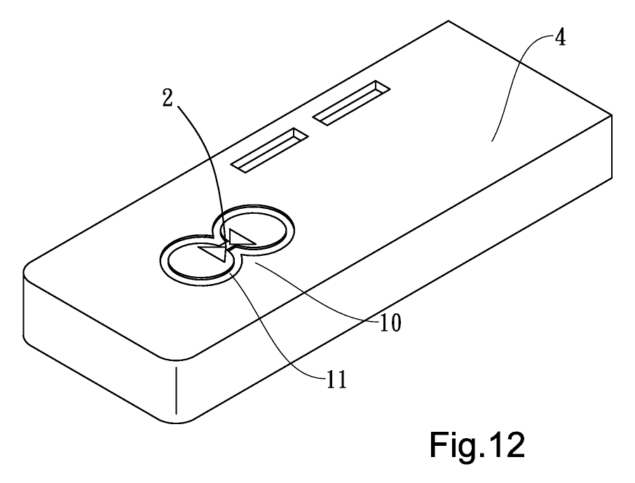

In additional, the substrate 1 is not limited to aluminum foil or tin foil materials; other materials may be used, like circuit boards, metal housings, metal conductors, nameplates, etc. As shown in FIG. 12, the slot antenna 11 is directly disposed on the metal housing 4 of a product, which can be made into a continuous RFID tag 10.

Compared to the prior art, the present invention has the following benefits:

1. Low material costs: conductive metal materials, such as aluminum foil, tin foil, etc., are easy to obtain and their prices are much cheaper than sliver paste and etching liquids.

2. Low equipment costs: no need for screen makers, developers, etching machines, printing machines, dryers.

3. High efficiency processing: a roll to roll procedure may be employed; the punching procedure, flip chip procedure, roller cutting slotting procedure, backing gluing procedure, testing procedure, packing procedure, etc, can all be finished at once.

4. Low manufacturing costs: automatic production, low labor requirements, and low water and energy consumptions.

5. Low wear and waste: no needs for paste, etching liquids; only wear on the roller cutting mold.

6. High yields: low error rates on materials and procedures, and high product yields.

7. Single material preparation: single aluminum or tin foil substrate preparation.

8. Single semi-finished product stocks: single aluminum or tin foil substrate after flip chip procedure is in stocks.

9. Low stocks damage: no problems such as emulsion evaporation or etch rusting.

10. Fast customized processes: no need for plate making, printing, flip chip, drying, testing procedures and their repeats. Only needs the cutting mold needs to be changed to directly cut out the slot antenna on the aluminum or tin foil substrate after the flip chip procedure, back gluing, testing, packaging and shipping.

11. Low electrical effects: with the fully conductive substrate and the slot antenna, the electrical characteristics of the tag are not easily affected by the target object.

12. Strength: aluminum or tin foil has high expendability and high elasticity.

13. Durability: aluminum and tin foil are able to endure high temperature and high moisture environments; therefore, a radio frequency tag with this substrate is similarly durable.

14. High shielding effects: with the fully conductive substrate and the slot antenna, the electrical properties of the tag are not easily affected by the materials of the target object such as a cup-like shape with a filler (water or oil conductor).

15. High reflecting ratio: the aluminum or tin foil is highly conductive, which can provide a high electromagnetic wave reflecting ratio in the radio frequency tag antenna.

16. Highly common structure: aluminum or tin foil is often used as a packaging material, which can be used for both the RFID and the packaging material.

Although the present invention has been explained in relation to its preferred embodiment, it is to be understood that many other possible modifications and variations can be made without departing from the spirit and scope of the invention as hereinafter claimed.

1-7. (canceled)

8. A manufacturing method for an RFID comprising:
(A) selecting a substrate with an entire side having an aluminum foil or tin foil conductive metal;
(B) spreading the substrate till a thickness thereof being less than 1 μm;
(C) rolling up the substrate as a substrate roll;
(D) punching a plurality of holes on the substrate corresponding to pins of an identification chip respectively with the holes spacing apart from each other with a predetermined distance;
(E) attaching the identification chip to the respective holes on the substrate roll with a conductive adhesive;
(F) forming a slot antenna on the substrate roll corresponding to the identification chip;
(G) treating the slot antenna with resin coating and filming processes to form a RFID.

9. (canceled)

10. The manufacturing method for an RFID as claimed in claim 8, wherein punching holes in step (D) is executed by a cutting mould or punch machine.

11. The manufacturing method for an RFID as claimed in claim 8, wherein forming the antenna in step (F) is executed by a cutting mould or laser cutter.

12. The manufacturing method for an RFID as claimed in claim 8, wherein the substrate roll in step (C) is performed for stock purposes; the substrate in step (F) is cut into the slot antenna according to a customized design.

13. (canceled)

14. The manufacturing method for an RFID as claimed in claim 8, wherein the substrate is selected from one of metal housings, circuit boards and metal nameplates.

15. A manufacturing method for an RFID comprising:
(A) selecting a substrate with an entire side having an aluminum foil or tin foil conductive metal;
(B) spreading the substrate till a thickness thereof being less than 1 μm;
(C) rolling up the substrate as a substrate roll;
(D) punching a plurality of holes on the substrate corresponding to pins of an identification chip respectively with the holes spacing apart from each other with a predetermined distance;
(E) forming a slot antenna on the substrate roll corresponding to the holes respectively;
(F) attaching the identification chip to the respective holes on the substrate roll with a conductive adhesive;
(G) treating the slot antenna with resin coating and filming processes to form a RFID.

16. The manufacturing method for an RFID as claimed in claim 15, wherein punching holes in step (D) is executed by a cutting mould or punch machine.

17. The manufacturing method for an RFID as claimed in claim 15, wherein forming the antenna in step (E) is executed by a cutting mould or laser cutter.

18. The manufacturing method for an RFID as claimed in claim 15, wherein the substrate roll in step (C) is performed for stock purposes; the substrate in step (E) is cut into the slot antenna according to a customized design.
